(19) United States
(12) Patent Application Publication
(10) Pub. No.: US 2003/0122369 A1
(43) Pub. Date: Jul. 3, 2003

(54) Process for marking a product in the form of a sheet of textile material or non-woven material

(76) Inventor: Guy Gilbert Chenel, Boulogne (FR)

Correspondence Address: DRINKER BIDDLE & REATH, ONE LOGAN SQUARE, 18TH AND CHERRY STREETS, PHILADELPHIA, PA, 19103-6996, US

(21) Appl. No.: 10/323,075

(22) Filed: Dec. 18, 2002

(30) Foreign Application Priority Data
Dec. 20, 2001 (FR) 01 16 537

(51) Int. Cl. G09C 3/00

(52) U.S. Cl. 283/74

(57) ABSTRACT

A product in the form of a thin, even very thin, sheet of textile material or non-woven material, which product is used in temporary decoration as a covering surface forming a display screen or a ceiling, especially for the get-up of exhibition sites, is marked with a linear inscription distributed in the direction of the characteristic lines of the product. The linear inscription is formed by a combination of dots and dashes representing coded signs. The line is a cutting line of the sheet.

### FIELD OF THE INVENTION

The present invention relates to a process for marking a thin, even very thin, product in the form of a sheet of textile material or non-woven material, which product is used in temporary decoration as a covering surface forming a display screen or a ceiling, especially for the get-up of exhibition sites.

### BACKGROUND OF THE INVENTION

There are many processes for marking products; for example, fabrics generally comprise marks or references printed on the edge which, in general, is used for assembly or is not used.

However, products exist which are used in large quantities for temporary decoration and which, for that purpose, are textile materials or non-woven materials that are very thin, being thus designed as a function of this temporary use.

For many reasons, it would be desirable to be able to mark such products in order to identify their origin and to avoid any dispute as to the quality of the products, compliance with the specifications or to detect counterfeiting or parallel manufacture. However, since those sheet-form products are very long products, the entire width of which is often used as far as the edges and constitutes a visible surface, it is not possible to provide markings because they would impair the appearance thereof.

### SUMMARY OF THE INVENTION

The present invention aims to overcome those disadvantages and proposes to develop a marking process for such products which makes it possible to identify the products accurately without the marking constituting an element appearing too directly on the product for an uninformed observer.

To that end, the invention relates to a marking process in which there is produced on the sheet-form product a linear inscription which is distributed in the direction of the characteristic lines of the product; this linear inscription is formed by a combination of dots and dashes representing coded signs.

This marking, in the form of a linear inscription composed of a combination of dots and dashes, is incorporated in an excellent manner in the structure of the sheet because the marking is carried out in the direction of the characteristic lines of the product. The characteristic lines are, in general, parallel with the length of the product.

It is advantageous to distribute the marking at random distances along the line in order further to disguise its appearance while at the same time enabling an informed person to locate the marking easily and to interpret it.

Since the marking is carried out linearly, regardless of the manner in which pieces are cut from the sheet supplied in a long length in the form of a roll, any piece will include a trace of marking enabling it to be identified.

This linear inscription may be marked, in particular, with an ink jet using an ink of an appropriate color selected in accordance with the color and the texture of the sheet. The inscription may also be a slight deformation, such as embossing or a removal of material, such as punching, the whole being incorporated in the characteristics of the material which is a light textile or a non-woven.

These slight local modifications in appearance are visible to the informed observer who knows substantially the place where the marking line is located and the type of marking so that he can identify it, while for the uninformed observer, who in addition is not in direct contact with the sheet but at some distance therefrom, this inconspicuous marking will be hardly perceptible. As, in addition, he does not expect to see a coded linear marking formed by a combination of dots and dashes, any slight irregularity or trace appearing on the product will be confused by him with the actual structure of the product.

The coded marking may be understood by informed observers at two different levels.

First Level

If the marking is coded in clear, such as, for example, if it is transcribed by the Morse alphabet, which is known to the public, it will inform the authorized users of the marked product. The marking will give information, for example, regarding the identity of the product, its trademark and its patents.

At this first marking level, the manufacturer will transmit to his clients the meaning of the marking.

Second Level

If the coded marking is additionally encrypted, that is to say, if the marking has been made unintelligible to any person who does not know the key of the code, it will constitute an efficient means of combating non-authorized use or counterfeiting. The encrypted marking will relate to information useful in the fight against illegal use and copying, such as, for example, the origin, the date of manufacture, the composition, etc.

At this second marking level, the manufacturer will not communicate the key of the code to his clients. He will reserve it only for observers entrusted with the task of helping him to combat counterfeiters.

Such controls may be important not only in checking the origin of the product but above all in preventing counterfeit products, which do not meet specific standards (for example, standards relating to protection against fire or other safety standards) would not be satisfied by counterfeit products.

According to a particularly advantageous feature, the inscription of the line of coded signs imitates a seam. This line is, in particular, made near the edge of the sheet.

According to a further advantageous feature, the coded signs are in binary code and especially in Morse code. Such coding is particularly advantageous because it can be encrypted, and it then gives the fraudster the impression of knowing how to decipher the code while not knowing the meaning of the encrypted combination. It will tend to imitate a real combination which will have little chance of being the code of origin, which will make the fraud even more detectable.

### BRIEF DESCRIPTION OF THE DRAWINGS

The present invention will be described in more detail hereinafter by means of the appended drawings in which:

FIG. 1 shows very schematically the implementation of the process,

FIG. 2 is a diagram of a strip provided with a marking according to the invention.

### DETAILED DESCRIPTION OF THE DRAWINGS

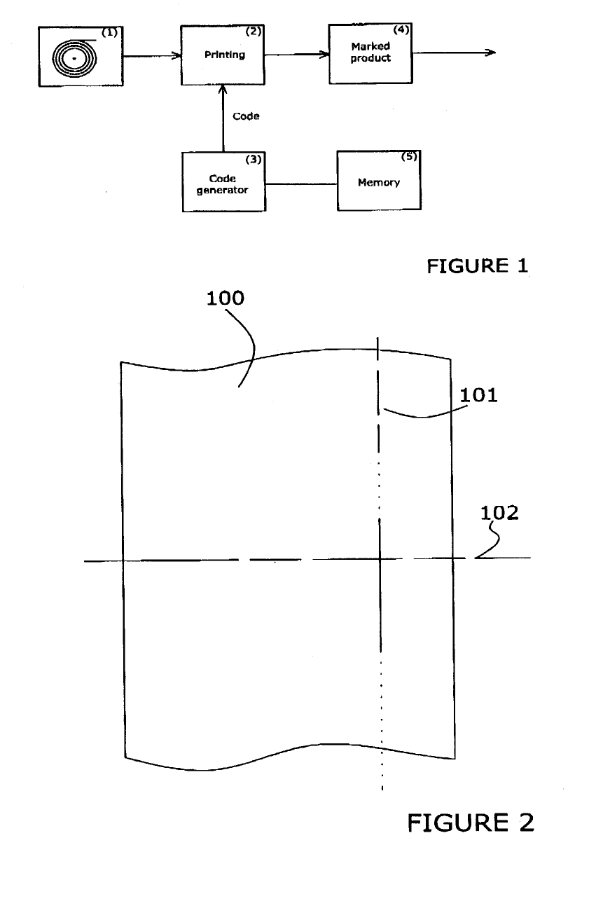

According to FIG. 1, starting from a product in the form of a sheet of products of textile material or non-woven material 1, such as thin sheets intended for temporary decoration, printing 2 is produced continuously on the long lengths by means of an installation which produces marks either by the introduction of material (for example, a linear inscription produced by an ink jet) or by the deformation or removal of material, such as embossing or punching. This printing is controlled by a code generator 3 which generates a predefined code which incorporates, for example, in a manner coded in clear or in an encrypted manner, information, such as a trade mark, a patent number, a place of manufacture, a date, a batch number. The product so marked 4 is ready for distribution. It is distributed either in the form of rolls or in the form of cut strips.

These products are then used especially for the temporary decoration of exhibition sites. They are used as a covering surface forming display screens. They may also be hung up as suspended or stretched strips.

The code generator 3 records the various codes which it generates in a memory 5 in order to preserve the trace thereof and to permit checks. This recording is preferably associated with a product or a manufacturing batch, the order number or a reference of this type.

The marking produced on a product 100, such as a strip represented in the form of a segment in FIG. 2, is constituted by a linear inscription 101 composed of a succession of dashes and dots separated by distances which may themselves correspond to a code.

This linear printing 101 is preferably continuous or practically continuous over the entire length of the product so that, regardless of the cutting line 102 separating the segments, each segment carries a trace of code enabling the sheet segment 100 to be identified.

The trace 101 is, as indicated above, a trace visible to an informed observer but which more or less blends in with the structure of the sheet 100 owing to the apparently insignificant nature of this trace 101. The trace may be made by ink jet printing, roller printing or another printing process or also by local deformation, such as embossing or removal of material, such as punching.

These various operations are carried out continuously as the strip 100 is unwound.

The printing is carried out in the course of unwinding and advantageously in the direction of the lines of the product. Those lines are generally parallel lines in the direction of the length regardless of whether the material is a textile material or a non-woven material.

Finally, the signs forming the coded line 101 are preferably signs coded in an arbitrary code, especially a binary code and, in particular, a Morse code. The Morse code may itself represent encrypted information and may not correspond to information in clear, such as the Morse alphabet.

The linear printing, such as described above, is not necessarily constituted by a single line. It may also be a bundle of lines or one or more lines close to each edge or distributed over the width of the product depending on the nature and the actual structure of the product. The coded signs may be distributed in random groups or may be separated by random distances making imitation even more difficult and facilitating its detection.

The linear printing may advantageously also be constituted by a single line carrying in succession information coded in clear and addressed to the users of the product and encrypted or secret information addressed only to observers who have been entrusted with the task of combating copying and counterfeiting.

1. Process for marking a product in the form of a thin sheet of textile material or non-woven material, which product is used in temporary decoration as a covering surface forming a display screen or a ceiling, comprising the step of producing on the sheet-form product a linear inscription which is distributed in the direction of the characteristic lines of the product, wherein this linear inscription is formed by a combination of dots and dashes representing coded signs.

2. Marking process according to claim 1, wherein the distribution of the inscriptions is effected at random distances.

3. Marking process according to claim 1, wherein the direction of the characteristic lines of the product is that of the length.

4. Marking process according to claim 1, wherein the direction of the characteristic lines of the product is that of the width.

5. Marking process according to claim 1, wherein the linear inscription is made by an ink jet trace or by local deformation of the sheet by embossing or punching.

6. Marking process according to claim 1, the inscription is made in imitation of a seam.

7. Marking process according to claim 1, wherein the direction of the characteristic lines of the product is the length or the width and the inscription is made near an edge of the sheet.

8. Marking process according to claim 1, wherein the coded signs represent information for identifying the manufacture of the product.

9. Marking process according to claim 8, wherein the coded signs represent information for identifying at least one datum selected from the group consisting of origin, batch, date, trademark, patent number.

10. Marking process according to claim 1, wherein the coded signs are in binary code.

11. Marking process according to claim 10, wherein the coded signs are those of the Morse alphabet.

12. Marking process according to claim 1, wherein the coded signs are rendered unintelligible to a person who does not know a secret code or key.

13. Marking process according to claim 1, wherein the inscriptions in the form of signs coded in clear follow inscriptions that are coded and encrypted, the latter being unreadable by persons who do not know the secret key.

14. A product in the form of a thin sheet of textile material or non-woven material, which product is used in temporary decoration as a covering surface forming a display screen or a ceiling comprising a linear inscription which is distributed in the direction of the characteristic lines of the product, wherein this linear inscription is formed by a combination of dots and dashes.

15. Product according to claim 14, wherein the linear inscription is made of an ink trace or of local deformation of the sheet.

16. Product according to claim 14, wherein the inscription resembles a seam.

17. Product according to claim 14, wherein the direction of the characteristic lines of the product is the length or the width and the inscription is made near an edge of the sheet.

18. Product according to claim 14, wherein the coded signs represent information for identifying the manufacture of the product.

19. Product according to claim 14, wherein the coded signs are unintelligible to a person who does not know a secret code or key.

20. Product according to claim 14, wherein the inscriptions in the form of signs coded in clear follow inscriptions that are coded and encrypted, the latter being unreadable by persons who do not know a secret key.
